(19) United States
(12) Patent Application Publication
(10) Pub. No.: US 2016/0217049 A1
(43) Pub. Date: Jul. 28, 2016

(54) Fibre Channel Failover Based on Fabric Connectivity

(71) Applicant: Nimble Storage, Inc., San Jose, CA (US)

(72) Inventors: Naveen Bali, Cary, NC (US); Richard J. Jooss, Chapel Hill, NC (US); Jason M. Fox, Cary, NC (US)

(21) Appl. No.: 14/997,435

(22) Filed: Jan. 15, 2016

Related U.S. Application Data
(60) Provisional application No. 62/106,706, filed on Jan. 22, 2015.

(51) Int. Cl. G06F 11/20

(52) U.S. Cl. CPC G06F 11/201; G06F 2201/85

(57) ABSTRACT

Methods, storage arrays and computer readable media for triggering a failover between an active controller and a standby controller of a storage array are provided. One method includes determining by the active controller a number of connected fabrics available between ports of the active controller and a host and determining by the standby controller a number of connected fabrics available between the ports of the standby controller and the host. The method further includes executing a policy configuration to determine if the number of connected fabrics for each of the active controller and the standby controller meet a threshold for triggering the failover. The failover being a forced failover where the active controller takes a role of the standby controller and the standby controller takes a role of the active controller.

### CLAIM OF PRIORITY

The present application claims priority to U.S. Provisional Patent Application No. 62/106,706, filed on Jan. 22, 2015, entitled “Fibre Channel Failover Based on Fabric Connectivity,” which is herein incorporated by reference.

### FIELD OF THE EMBODIMENTS

The present disclosure provides methods, storage arrays and computer readable media for triggering failover based on fabric connectivity in Fibre Channel implementations.

### BACKGROUND

Storage arrays are used to store data. Commonly, storage arrays have at least one controller for managing access to storage media of the storage array. The storage media of a storage array may include one or more hard disk drives (HDDs) and/or one or more solid state drives (SSDs). Storage arrays are typically configured with connections to servers via one or more switches to enable efficient and reliable access between the servers and storage arrays. The switches and/or other interconnecting network infrastructure is sometimes referred to as the “fabric.” There are various types of fabric protocols. One commonly used fabric protocol is the Fibre Channel protocol. In a Fibre Channel protocol, the storage array operates as a Fibre Channel target, which interconnects via one or more fabrics to one or more imitators, e.g., Fibre Channel configured servers connected to one or more fabrics and/or one or more storage arrays. Often, storage arrays may have two controllers for redundancy, and each of the controllers may have one or more Fibre Channel (FC) adapter cards.

In some configurations, storage arrays are configured with logic to process failover. Failover, in the context of storage arrays with two controllers, means that if an active controller fails or is not operating properly, a standby controller can be designated as the active controller. One such logic used to process failover, in the context of Fibre Channel connections to a fabric or fabrics implements a “link counting” process. Link counting means that each of the active controller and standby controller will count the links it has available to fabrics leading to an initiator host or hosts.

In one example, the active controller of a storage array may have three links to a first fabric and one link to a second fabric, each connecting to a host initiator. In this same example, the standby controller of the storage array may only have two links to the host initiator; one via the first fabric and one via the second fabric. The link counting process will identify the active controller, having four links to the initiator host, as preferred over the standby controller (and no failover would be triggered). If the active controller loses the link to the second fabric, the active controller will still have more links than does the standby controller, which has two links. However, the lost link by the active controller left the active controller with three links all through the first fabric. This failover processing will still opt to keep the active controller as the active controller, even though the standby controller has better redundancy given its two links to the initiator host via two separate fabrics. Based at least on this example, it is evident that link counting for failover processing, in Fibre Channel implementations, has drawbacks.

It is in this context that embodiments claimed herein arise.

### SUMMARY

Methods, systems, storage arrays, and computer readable media are provided for examining fabric connectivity between a storage array and a host. In some embodiments, a process is executed by the storage array to determine a number of Fibre Channel connected fabrics available for each controller of the storage array to a specific host. Based on the determined number of connected fabrics available to each controller, an algorithm or policy is executed to determine when failover should be forced, which may optimize performance of the storage array.

In one embodiment, a method for triggering a failover between an active controller and a standby controller of a storage array is provided. The method includes determining by the active controller a number of connected fabrics available between ports of the active controller and a host and determining by the standby controller a number of connected fabrics available between the ports of the standby controller and the host. The method further includes executing a policy configuration to determine if the number of connected fabrics for each of the active controller and the standby controller meet a threshold for triggering the failover.

In some embodiments, the method further includes comparing the number of connected fabrics between the ports of the active controller and the standby controller and the host, wherein the comparing is used by the policy configuration to determine if the threshold for triggering the failover is present.

In some embodiments, the policy configuration is selectable to change the threshold for triggering the failover.

In some embodiments, the failover is a process that switches a designation and functionality of the active controller and the standby controller, such that the active controller takes a role of the standby controller and the standby controller takes a role of the active controller.

In some embodiments, the policy configuration requires that the standby controller have more connected fabrics than does the active controller to meet the threshold for triggering the failover, and the failover is a process that switches a designation and functionality of the active controller and the standby controller, such that the active controller takes a role of the standby controller and the standby controller takes a role of the active controller.

In some embodiments, the policy configuration requires that the standby controller have more than zero connected fabrics and the active controller has zero connected fabrics to meet the threshold for triggering the failover, and the failover is a process that switches a designation and functionality of the active controller and the standby controller, such that the active controller takes a role of the standby controller and the standby controller takes a role of the active controller.

In some embodiments, the policy configuration requires that the standby controller have all connected fabrics of the active controller, plus some other connected fabric to meet the threshold for triggering the failover, and the failover is a process that switches a designation and functionality of the active controller and the standby controller, such that the active controller takes a role of the standby controller and the standby controller takes a role of the active controller.

In some embodiments, the threshold for triggering the failover further requires detecting a drop in performance of the storage array.

In some embodiments, the policy configuration is dynamically adjusted based on a type of data being processed or during specific periods of time.

In some embodiments, wherein the failover is a forceful trigger based on analysis of the connected fabrics to the active controller and the standby controller operating a Fibre Channel process.

In some embodiments, wherein an override setting is triggered to prevent the failover during operation of certain administration tasks of the storage array.

In another embodiment, a storage array is disclosed. The storage array includes an active controller for operating storage operations in accordance with a Fibre Channel protocol and a standby controller for operating storage operations in accordance with the Fibre Channel protocol. The active controller and the standby controller are programmed to determine a number of connected fabrics available between ports of the active controller and the standby controller to a host. The active controller is configured to execute a policy configuration to determine if the number of connected fabrics for each of the active controller and the standby controller meet a threshold for triggering the failover.

In another embodiment, computer readable media is provided for triggering a failover between an active controller and a standby controller of a storage array.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1A illustrates one example view of a storage array SCSI target stack in accordance with one embodiment.

FIG. 1B illustrates an example of a storage array with an active controller and a standby controller in accordance with one example.

FIG. 2A shows an example of the active controller, which is configured with a data services daemon in accordance with one example.

FIG. 2B illustrates an example configuration of a storage array connected to a fabric that in turn connects to a host, in accordance with one embodiment.

FIG. 3 illustrates an example where the storage array has the active controller and connected to various fabrics that provide connection to the host, in accordance with one embodiment.

FIG. 4 illustrates an example of the storage array operating where the standby controller has two connected fabrics to the host, while the active controller has no connections to any fabric to the specific host, in accordance with one embodiment.

FIG. 5 illustrates an example where the storage array is connected to several fabrics leading to the host, in accordance with one embodiment.

FIG. 6 illustrates an example architecture of a storage array, according to one embodiment.

### DETAILED DESCRIPTION

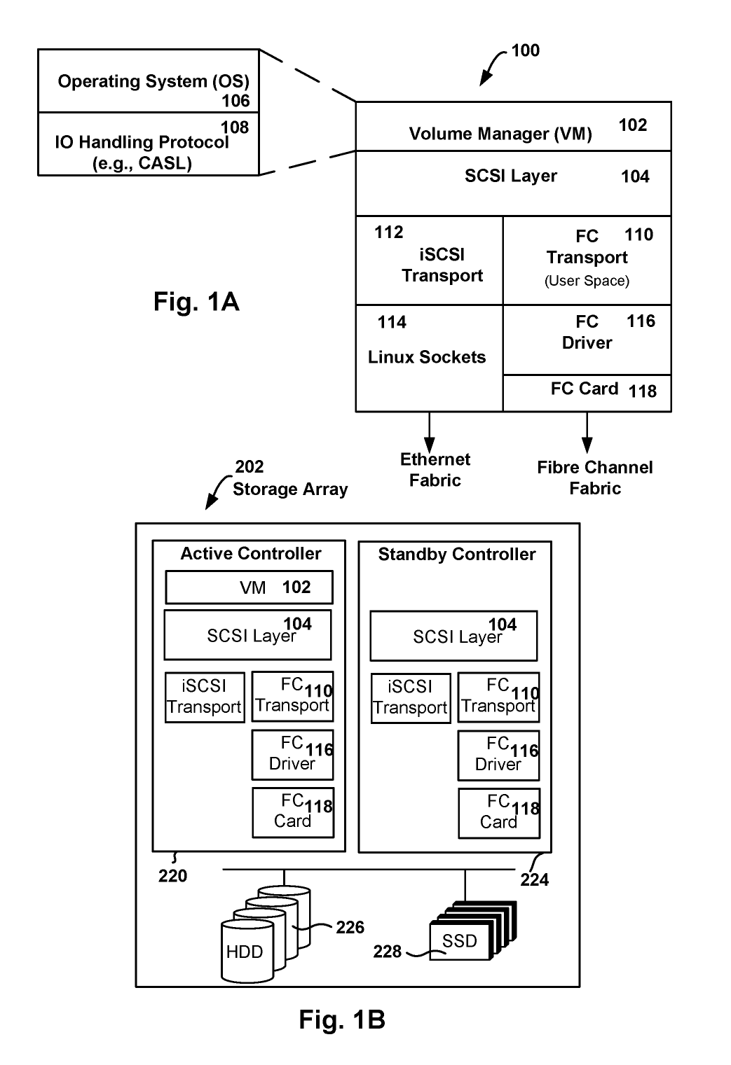

The following embodiments describe methods, devices, systems, and computer programs for storage arrays, which are configured for network connectivity in accordance with one or more protocols. Embodiments of the invention are discussed below with reference to FIGS. 1A-6. However, those skilled in the art will readily appreciate that the detailed description given herein with respect to these figures is for explanatory purposes as the invention extends beyond these limited embodiments.

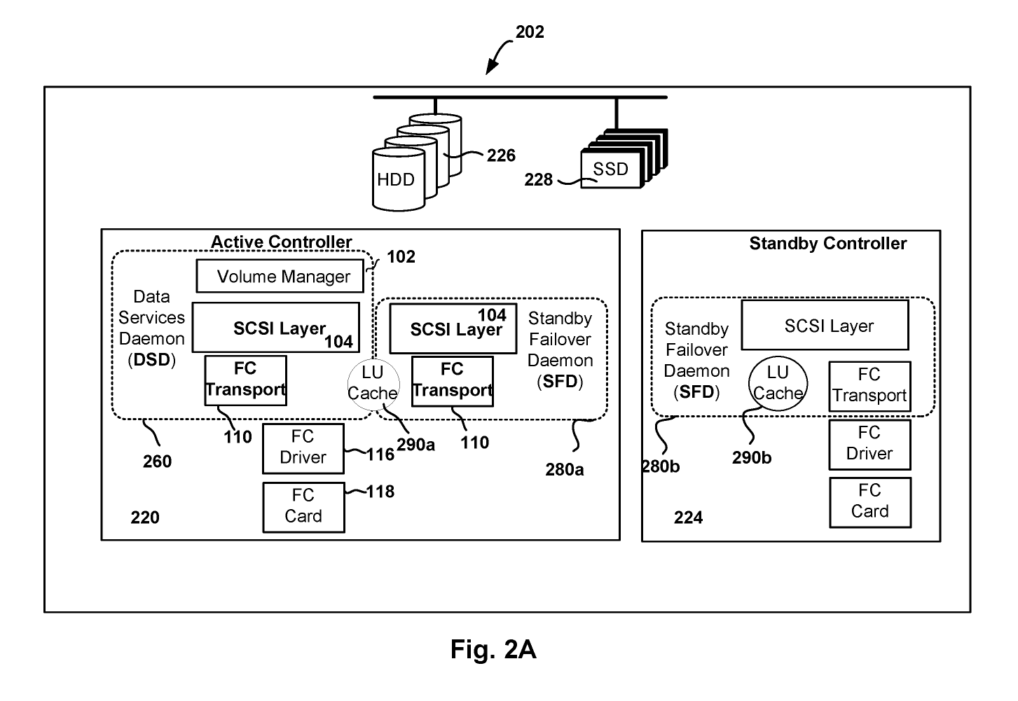

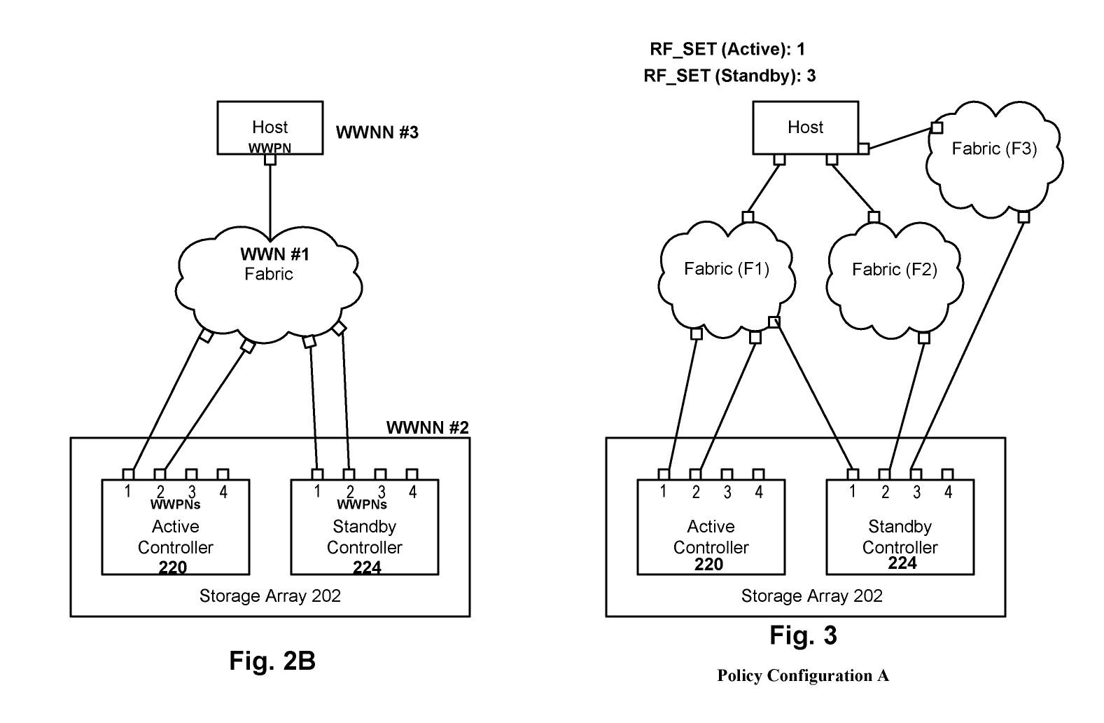

In one embodiment, methods are provided for executing analysis of fabric connectivity between storage arrays and a host. In some embodiments, a process is executed by each controller in a storage array to determine the number of Fibre Channel connected fabrics available for each controller to a specific host. Based on the determined number of connected fabrics available for each controller, an algorithm or policy is executed to determine when failover should occur. As described herein, failover is a process that switches the designation and functionality of controllers in a storage array from being active controller or standby controller. For instance, if the standby controller has more connected fabrics to the host than the active controller, the roles of the controllers will switch such that the original standby controller will become the active controller and the original active controller will become the standby controller. Further discussion and examples associated with the fabric-conductivity based failover processes is provided with reference to FIGS. 2B-5 below.

One protocol is iSCSI (Internet Small Computer System Interface). iSCSI is used for interconnecting storage arrays to a network, which enables the transport of SCSI commands over Ethernet connections using TCP/IP (i.e., for IP networks). In such configurations, an iSCSI storage implementation can be deployed using Ethernet routers, switches, network adapters, and cabling.

Another protocol is Fibre Channel. Fibre Channel is a high-speed network technology, which is primarily utilized in storage area networks (SANs). Storage arrays are the target devices in a SAN configuration, wherein the fabric and initiators all intercommunicate using the Fibre Channel protocol. Fibre Channel Protocol (FCP) is a transport protocol (similar to TCP used in IP networks) that predominantly transports SCSI commands over Fibre Channel networks.

In accordance with various embodiments described herein, a storage array configurable for Fibre Channel mode or iSCSI mode is provided. The storage array can include logic and hardware to operate in the iSCSI mode and can implement one or more Ethernet cards. To operate in the Fibre Channel mode, the storage array is provided with a Fibre Channel (FC) card (e.g., a hardware card of the controller). The FC card is the link between the Fibre Channel physical network (i.e., PHY) and the Fibre Channel driver (FC) driver of the storage array.

FIG. 1A provides one example view of a storage array SCSI target stack 100. The stack includes a volume manager (VM) 102, which broadly includes the operating system (OS) 106 of the storage array and an IO handling protocol that processes read and write IO commands to storage of the storage array. The IO handling protocol, in one embodiment, is referred to herein as a cache accelerated sequential layout (CASL) process, which intelligently leverages unique properties of flash and disk of the storage array to provide high performance and optimal use of capacity. CASL functions as the file system of the array, albeit processing is generally performed at the block level instead of file level.

Below the VM 102 is a SCSI layer 104, which is configured to handle SCSI commands. In one embodiment, the SCSI layer 104 has been implemented to be independent of iSCSI transport functionality. For example, in storage arrays configured for pure iSCSI mode operation, the iSCSI transport 112 may include logic that is shared by the SCSI layer 104. However, to implement a Fibre Channel operating storage array, the SCSI layer 104 has been implemented to remove dependencies on the iSCSI transport 112. The SCSI target stack 100 further includes a Fibre Channel (FC) transport 110, which functions as user space for running various processes, which are referred to herein as daemons. The user-space of the FC transport 110 serves as the conduit to the SCSI target (i.e., SCSI layer 104).

A Fibre Channel (FC) driver 116 is further provided, which is in communication with a Fibre Channel (FC) card 118. In one embodiment, in order to interact with the FC card 118, which is a dedicated hardware/firmware, a dedicated FC driver 116 is provided. For each FC card 118 (i.e., supporting one or more ports) in an array, an instance of the FC driver 116 is provided. In one embodiment, a single FC card 118 may be used. The FC card 118 and FC driver 116 may be used to access all FC target ports. In some configurations, however, multiple kernel driver threads may be used to improve performance. In still other configurations, different FC cards 118 from different vendors may be simultaneously supported or used in a single controller. In such a configuration, separate drivers for these device types may be used. The FC driver 116 is, in one embodiment, a kernel level driver that is responsible for interacting directly with the FC card 118 to retrieve incoming SCSI commands, request data transfer, and send SCSI responses, among other things. In one embodiment, the FC card 118 may be an adapter card, which includes hardware, firmware and software for processing Fibre Channel packets between the Fibre Channel fabric and the FC driver. In one specific example, the FC card 118 may be a Fibre Channel Host Bus Adapter (HBA) card, available from Emulex Corporation, located in Costa Mesa, California. If the storage array is configured for iSCSI mode, Linux sockets are used to communicate with a TCP/IP network interface card (NIC), for communication with an Ethernet fabric.

FIG. 1B illustrates an example of a storage array 202, which includes an active controller 220, a standby controller 224, and storage (i.e., hard disk drives (HDDs) 226, and solid state drives (SSDs) 228). This configuration shows the storage array SCSI target stack 100 usable in each of the active and standby controllers 220 and 224, depending on the state of operation. For example, if the active controller 220 is functioning normally, the standby controller is not serving IOs to and from the storage, and ports of the standby controller are simply operational in a standby (SB) state in accordance with an asymmetric logical unit access (ALUA) protocol. The ALUA protocol is described in more detail in a Fibre Channel standard, entitled “Information technology—SCSI Primary Commands—4 (SPC-4)”, revision 36s, dated 21 Mar., 2014 (Project T10/BSR INCITS 513), which is incorporated herein by reference. Generally speaking, ALUA is a multi-pathing method that allows each port (e.g., Linux-IO Target) to manage access states and path attributes using assignments that include: (a) active/optimized (AO); (b) active/non-optimized (ANO); (c) standby (SB); unavailable (UA); and (d) logical block dependent (LBD).

In the example of FIG. 1B, it is noted that the standby controller 224 may not have the iSCSI transport 112 during the time it operates as a “standby” controller. If failover occurs and the standby controller 224 becomes the active controller 220, then the iSCSI transport 112 will be populated. Note also, that during Fibre Channel operation, the FC transport 110 is the module that is in operation. Alternatively, if the storage arrays are used in an iSCSI configuration, the iSCSI transport 112 will be needed, along with the Linux Sockets 114 to enable Ethernet fabric communication.

FIG. 2A shows an example of the active controller 220, which is configured with a data services daemon (DSD) 260. DSD 260 is designed to provide full access to the storage array 202 via the VM 102, which includes serving IOs to the volumes of the storage array 202 (e.g., in response to initiator access requests to the SCSI target storage array 202). The DSD 260 of the active controller 220 is a user space process. For failover capabilities within the active controller 220 itself, the user space of the active controller 220 also includes a standby failover daemon (SFD) 280a. The SFD 280a is configured as a backup process that does not process IOs to the volumes of the storage array 202, but can provide limited services, such as responding to information SCSI commands while the DSD 260 is re-started (e.g., after a crash). If the SFD 280a takes over for the DSD 260, the I_T Nexus (i.e., connection) between initiators and the target array remain un-terminated.

The standby controller 224 of the storage array 202 is also configured with an SFD 280b in its user space. As noted above, the ports of the standby controller 224 are set to standby (SB) per ALUA. If a command is received by the SFD of the standby controller, it can process that command in one of three ways. In regard to a first way, for many commands, including READ and WRITE, the SCSI standard does not require the target to support the operation. For this case, SFD 280b returns the SCSI response prescribed by the standard to indicate non-support. In a second way, among the mandatory-to-support SCSI commands, there are certain commands for which initiators expect quick response under all conditions, including during failover.

Examples include, without limitation, INQUIRY, REPORT_LUNS, and REPORT_TARGET_PORT_GROUPS. For these commands, SFD 280b responds locally and independently. In a third way, for other mandatory-to-support SCSI commands (such as PERSISTENT_RESERVATION_IN/OUT), the SFD 280b will depend on the DSD 260 process running on the active controller 220. Thus, a forwarding engine is used to forward SCSI commands from the standby controller 224 to the active controller 220. The active controller 220 will process the commands and sends responses back to the standby controller 224, which will in turn send them to the initiator.

For commands that need to be processed locally, all information required to create an accurate and consistent SCSI response will be stored locally in an LU cache 290a/b. In one embodiment, a logical unit (LU) cache will be present on each of the active and standby controllers 220/224, and consistency methods ensure that all LU cache states are updated. The SFD 280a/b uses the LU cache 290a/b to independently respond to a small number of commands, such as Inquiry, Report LUNs and RTPG.

Furthermore, in Fibre Channel, each FC transport endpoint is identified by a Fibre Channel (FC) World Wide Node Name (WWNN) and World Wide Port Name (WWPN), or generally referred to as World Wide Name (WWN). It is customary and expected that all ports for a given target advertise the same single WWNN. The client OS storage stack will establish a single FC connection to each available FC transport endpoint (WWNN/WWPN pair). In the example of storage array 202, it may have two FC transport endpoints for each of the active controller 220 and the standby controller 224. That is, the active controller 220 may have two ports (i.e., two WWNN/WWPN pairs), and the standby controller 224 may also have two ports (i.e., two WWNN/WWPN pairs). It should be understood that the configuration of the storage array 202 may be modified to include more or fewer ports.

For an FC configuration, because there are multiple LUNs accessible through an SCSI I_T nexus, and there is no free-format “target name” into which lookup information can be embedded, logical unit number (LUN) mapping is maintained for each initiator. The LUN mapping is configured to persistently store the mapping information and maintain consistency across reboots. The LUN mapping is stored in the LU cache 290a/b. The DSD 260 and SFD 280a and 280b are provided with direct access to the LU cache 290a/b. The LU cache 290a/b will also store inquiry data and port state information. In one embodiment, a GDD (Group Data Daemon) and a GMD (Group Management Daemon) will maintain LUN mapping information for each initiator. GDD and GMD are management processing for configuring the storage array 202 and for maintaining settings and configurations during operation. GDD, from SCSI perspective, is configured to work with SCSI layer 104 to handle SCSI Reservation and TMF (task management function). In one embodiment, GDD will support iSCSI login and connection re-balancing for when the storage array 202 is configured and used as an iSCSI target.

In a storage array having an active controller and a standby controller, it is possible that one controller may have paths to a different set of fabrics than the other. In one implementation, a process is executed by each controller to examine the fabric to which each of that controller's ports is attached, and to thus identify the set of reachable fabrics (“RF_SET”) for the entire controller. Then, once the RF_SET for each controller is known, the process compares the RF_SETs of the active and standby controllers, applying a policy to determine whether the role of active controller should be transferred to the standby controller, and the active controller should become the standby controller. The policy is defined by logic that analyzes the number of fabrics reachable by each controller and if a threshold is met, as defined by the logic, failover is triggered.

This action, transferring roles between active and standby controllers, is referred to herein as “fabric connectivity-based automatic failover”.

FIG. 2B illustrates an example configuration of a storage array 202 connected to a fabric that in turn connects to a host, in accordance with one embodiment. In this example, each of the active controller 220 and standby controller 224 has a plurality of ports. The ports are numbered 1, 2, 3, 4, and each port will have its own worldwide port name (WWPN). Each of the ports of the active controller 220 and the standby controller 224 will have unique WWPNs, and the designation of port numbers 1, 2, 3, 4 are only being used to illustrate connections to one or more fabrics. In general, the storage array 202 will also have a unique worldwide node name (WWNN). In this illustration, the fabric has a worldwide name (WWN) #1, the storage array 202 has WWNN #2, and the host has WWNN #3. The WWNN#2 of the storage array 202 is used to identify it as a target to initiators, such as the host. Generally speaking, the fabric may have a plurality of switches that also have the same WWN #1, thus defining the interconnected network of switches part of the same fabric.

A typical networking configuration, a storage array 202 may be connected to more than one fabric and more than one host. For purposes of describing the fabric connectivity—based automatic failover processes, discussion will be had with respect to connection to a single host, but it should be understood that the algorithm can also be repeated for other hosts that the storage array 202 may be connected. If for example it is more important for the storage array 202 to be connected to a specific host, the analysis and application of the policy configurations can be tailored to give priority to the specific host, over other hosts. For instance, if it is determined that more connected fabrics are present via the standby controller 224 to a specific host that is of lesser importance, those connected fabrics can be ignored and priority can be given to the active controller 220 which may have more connected fabrics to a more important host.

As shown, each of the active controller 220 and the standby controller 224 may have their ports routed to the same or different fabrics. As in the illustration of FIG. 2B, sometimes one of the active controller 220 or standby controller 224 of the storage array 202 may be connected to the same fabric via more than one port, which provides redundancy in case of failure. It should also be understood that the ports provided by the active controller 220 and the standby controller 224 may include many more ports than ports 1-4. It should be understood that the ports provided by a particular controller are ports associated with a Fibre Channel (FC) card, which is connected to a slot that provides bus access to the controller. A particular FC card may include two ports, so as to provide for ports, two FC cards may be connected to bus slots of a specific controller.

Using this configuration, each of the active controller 220 and the standby controller 224 will include two FC cards. In other embodiments, the FC cards may be quad cards, which enable or provide four ports each, and if two FC cards are connected to each controller, each controller will have eight ports. Still further, it is possible to implement virtualization for the port generation at each of the active and standby controllers 220 and 224. Virtualization would allow for the generation of many more ports per controller, and such configuration would be dependent upon the desired network connection implementation. Therefore, the following example should be viewed broadly to allow for many connections between a storage array 202 and one or more fabrics. These connections to the fabrics can then be counted by each controller in the storage array 202.

As described above, a process executing on each of the active controller 220 and the standby controller 224 can execute to count the number of fabrics that each is able to access to provide connection to a particular host. Once it is determined how many fabrics a particular controller has connectivity to, a configuration policy is implemented to determine whether the active controller 220 should remain as active controller 220 or if failover processing should occur such that the original standby controller 224 becomes active controller 220 and the original active controller 220 becomes the standby controller 224.

### Policy Configuration A:

The RF_SET policy may indicate that a fabric connectivity-based automatic failover should be performed whenever it is determined that the standby controller has more connected fabrics than the active controller. That is:

sizeof (standby_controller_RF_SET)>sizeof (active_controller_RF_SET)

FIG. 3 illustrates an example where the storage array 202 has the active controller 220 and 224 connected to various fabrics F1-F3, which provide connection to the host. As shown, the active controller 220 is connected to fabric F1 for making connection to the host. Standby controller 224 is shown connected to fabrics F1, F2, and F3. Each of the fabrics F1-F3 provide connection to the host. As described above, at periodic points during operation or when performance drops below a threshold, the storage array 202 will process an algorithm such that each of the active controller 220 and standby controller 224 will test the network to determine the number of connected fabrics available between the respective controller and the host. In this illustration, the active controller 220 has determined that it has a one (1) fabric connection to the host, even though it has two (2) separate links between ports of the active controller 220 and the fabric F1.

The standby controller 224 has determined that it has three (3) connected fabrics to the host via fabrics F1, F2 and F3. For the standby controller 224, no redundant links are provided between the standby controller 224 and any one of the fabrics F-1-F3, but more connected fabrics to the host are identified than those of the active controller 220. In accordance with policy configuration A, failover will occur so that the original active controller 220 will become the standby controller 224, and the original standby controller 224 will become the active controller 220. Failover includes transferring processes that were executed by the active controller 220 to the standby controller 224, and then continuing to execute in that configuration until it is later determined that the standby controller 224 has more connected fabrics to the host than does the active controller 220. As noted above, this process can be scheduled to occur at periodic times during operation or can be triggered when performance metrics show delays or failure in data transfer between the host and the storage array 220.

### Policy Configuration B:

The RF_SET policy may indicate that a fabric connectivity-based automatic failover should be performed only when it is determined that the standby controller has some connected fabrics, while the active controller has no connected fabrics. That is:

sizeof (standby_controller_RF_SET)>0 AND

sizeof (active_controller_RF_SET)=0

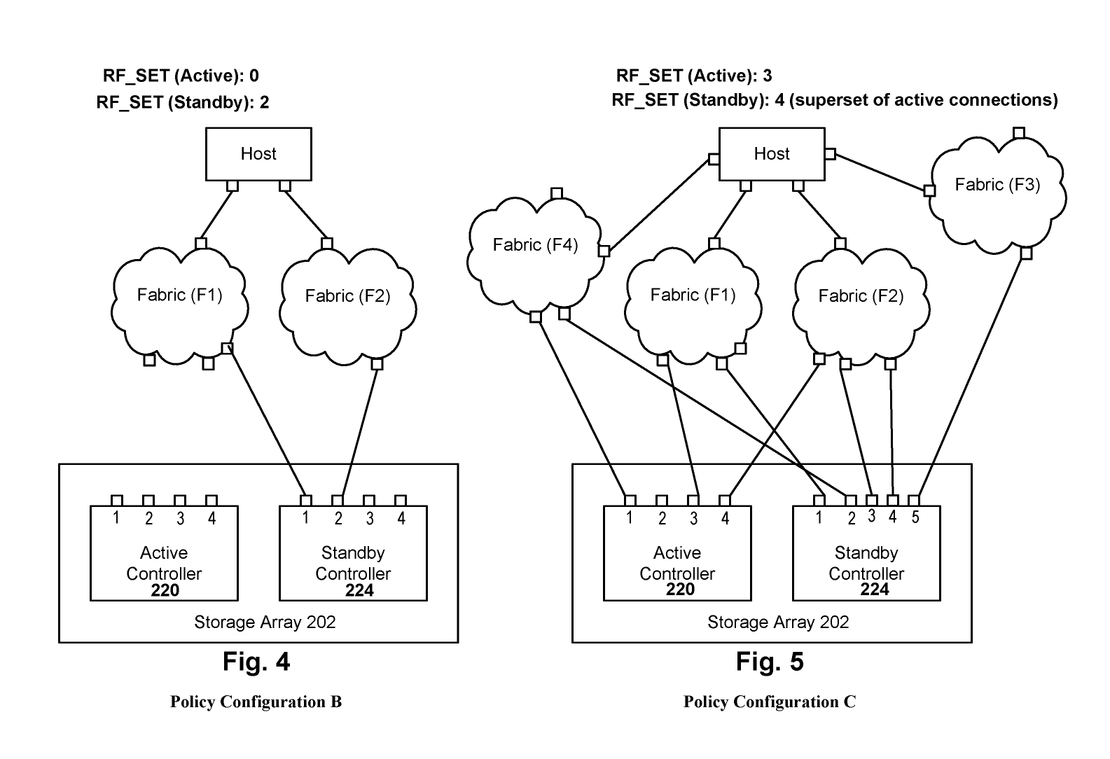

FIG. 4 illustrates an example of the storage array 202 operating where the standby controller 224 has two connected fabrics to the host, while the active controller 220 has no connections to any fabric to the specific host. As noted above, it is possible that the active controller 220 can have access to another host which is less important, but in this example, connections to the illustrated host are zero for the active controller 220. In this example, when policy configuration B is implemented, failover will occur because the standby controller 224 more than zero connected fabrics to the host and the active controller 220 has zero connected fabrics to the host.

### Policy Configuration C:

The RF_SET policy may indicate that a fabric connectivity-based automatic failover should be performed only when it is determined that the standby controller's RF_SET is a proper superset of the active controller's RF_SET. That is:

the standby controller's RF_SET contains all members (reachable fabrics) of the active controller's RF_SET, plus some other members

FIG. 5 illustrates an example where the storage array 202 is connected to several fabrics F1, F2, F3, and F4 leading to the host. As mentioned above, the number of ports supported by each controller can vary depending on the configuration of FC cards and whether virtualization has been implemented. This example shows that standby controller 224 has five ports, but more ports than five can be present but not shown for purposes of illustration of the connected fabrics made by the storage array 202. Therefore, it should be understood that the number of ports illustrated in FIG. 5 are only exemplary for purposes of showing connections to the fabrics. With this in mind, it is shown that active controller 220 has connected fabrics to fabric F4, F1, and F2. It is also shown that the standby controller 224 has connected fabrics to F1, F4, F2, and F3.

Standby controller 224 also has redundant connected fabrics to fabric F2 to the host. When the process is executed by each of the active controller 220 and the standby controller 224 to count the number of connected fabrics to the host, the processing will determine that the active controller 220 has three (3) connected fabrics to the host and the standby controller 224 has four (4) connected fabrics to the host. When policy configuration C is implemented, a determination is made as to whether the standby controller's connected fabrics contain all members (reachable fabrics) of the active controller's connected fabrics, plus some other members. In this illustration it is true that the standby controller 224 has a superset of the active connected fabrics to the host, with respect to the connected fabrics of the active controller. In accordance with this policy configuration C, the system will then trigger a failover such that the original standby controller 224 will become the active controller 220 and the original active controller 228 will become the standby controller 224. As mentioned above, this process can be recurring periodically, or when some threshold has been met that shows a drop in performance, or a failure in interconnectivity between the storage array 220 and the host.

It should be understood that the type of policy configuration implemented, such as policy configurations A, B and C can be chosen by a setting. The setting can be implemented depending on the robustness of the number of fabrics needed to a specific host in a network topography. Still further, selection of a policy configuration can also be made based on the frequency at which failover will occur to accommodate the specific policy configuration. For instance, some policy configurations will trigger more failovers than others, but selection of the policy configuration can be tailored for the specific criticality of the system and data which is being served by the storage array 202. In still other embodiments, it is possible to implement two or more of the policies at different points in time or based on the type of data being processed. For instance, it is possible to dynamically select policy configuration during a specific period of time or when processing the specific types of data, and then reverting back to another policy.

Setting of when certain policies will be in force can be programmatically set by the user or recommended by the system based on historical metrics. As such, the same or combinations of these policy configurations may be run at different points in time, either at programmed intervals or when a performance drop is detected.

In some embodiments, additional policy configurations can be made and enforced from time to time, in addition to policy configurations A-C. For instance, a simple policy configuration may be to not trigger failover if both the active controller 220 and the standby controller 224 have the same number of connected fabrics, i.e., they are symmetric. In other embodiments, policies can be defined on the fly via an administrator interface. In still other embodiments, policies can be recommended to administrators based on historical success of certain policies, as implemented by other storage arrays.

Furthermore, it should be understood that the term “failover” is meant to convey an active process that directs switching between controllers. It is possible that failover could be triggered automatically when a controller fails, such as the active controller, and the standby controller takes over as the active controller. However, in terms of switching between controllers for purposes of re-designating the active and standby controllers, failover is simply a process that allows for the roles of the controllers to be switched. This is a similar process that occurs when actual failure occurs that requires a true failover, but the failover is automatically or forcefully triggered during the switching when the roles of the controllers are reversed for purposes of improving connectivity between the storage array 202 and a host, which can be provided with more connected fabrics to the host for reliability.

In still another embodiment, triggering failover can be controlled to not occur when certain administrative tasks are made on a particular storage array 202. For example, if an administrator takes a port of the storage array 202 off line, an override setting can be triggered so that a failover does not get triggered. In some embodiments, a process can be run before triggering a failover to determine if particular ports are down due to failover or some other temporary reasons that should not cause failover. In some embodiments, if the storage array 202 is being adjusted or configured by an administrator, a process may delay triggering of analysis routines that may trigger a fabric connectivity failover.

### Example Storage Array Infrastructure

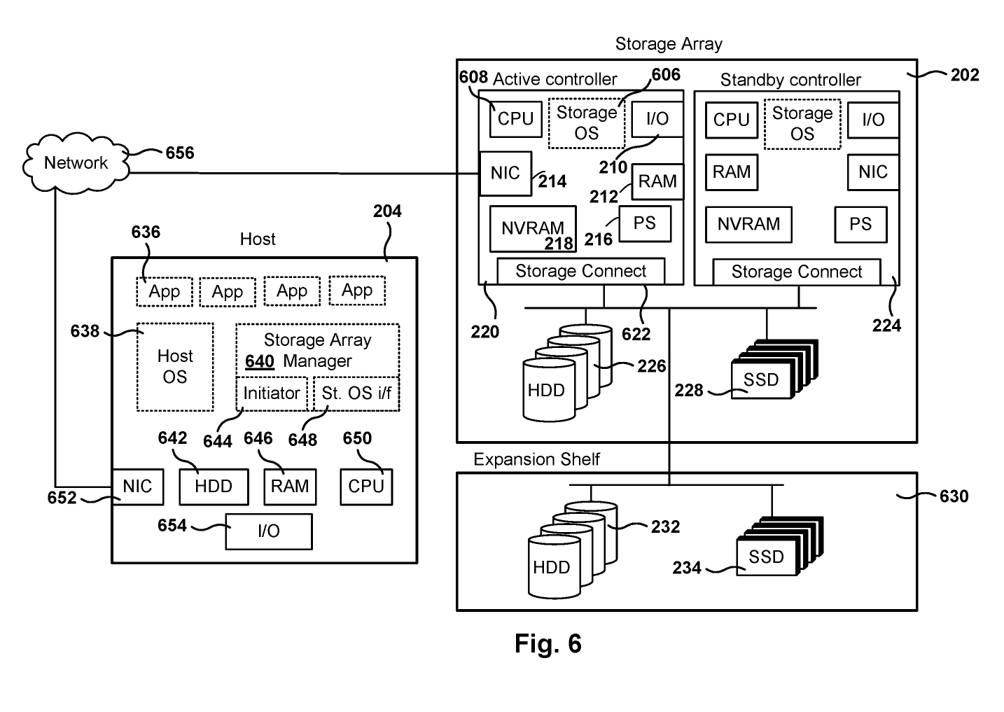

FIG. 6 illustrates an example architecture of a storage array 202, according to one embodiment. In one embodiment, storage array 202 includes an active controller 220, a standby controller 224, one or more HDDs 226, and one or more SSDs 228. In one embodiment, the controller 220 includes non-volatile RAM (NVRAM) 218, which is for storing the incoming data as it arrives to the storage array. After the data is processed (e.g., compressed and organized in segments (e.g., coalesced)), the data is transferred from the NVRAM 218 to HDD 226, or to SSD 228, or to both.

In addition, the active controller 220 further includes CPU 608, general-purpose RAM 212 (e.g., used by the programs executing in CPU 608), input/output module 210 for communicating with external devices (e.g., USB port, terminal port, connectors, plugs, links, etc.), one or more network interface cards (NICs) 214 for exchanging data packages through network 656, one or more power supplies 216, a temperature sensor (not shown), and a storage connect module 622 for sending and receiving data to and from the HDD 226 and SSD 228. In one embodiment, the NICs 214 may be configured for Ethernet communication or Fibre Channel communication, depending on the hardware card used and the storage fabric. In other embodiments, the storage array 202 may be configured to operate using the iSCSI transport or the Fibre Channel transport.

Active controller 220 is configured to execute one or more computer programs stored in RAM 212. One of the computer programs is the storage operating system (OS) used to perform operating system functions for the active controller device. In some implementations, one or more expansion shelves 630 may be coupled to storage array 202 to increase HDD 232 capacity, or SSD 234 capacity, or both.

Active controller 220 and standby controller 224 have their own NVRAMs, but they share HDDs 226 and SSDs 228. The standby controller 224 receives copies of what gets stored in the NVRAM 218 of the active controller 220 and stores the copies in its own NVRAM. If the active controller 220 fails, standby controller 224 takes over the management of the storage array 202. When servers, also referred to herein as hosts, connect to the storage array 202, read/write requests (e.g., IO requests) are sent over network 656, and the storage array 202 stores the sent data or sends back the requested data to host 204.

Host 204 is a computing device including a CPU 650, memory (RAM) 646, permanent storage (HDD) 242, a NIC card 652, and an IO module 654. The host 204 includes one or more applications 636 executing on CPU 650, a host operating system 638, and a computer program storage array manager 640 that provides an interface for accessing storage array 202 to applications 636. Storage array manager 640 includes an initiator 644 and a storage OS interface program 648. When an IO operation is requested by one of the applications 636, the initiator 644 establishes a connection with storage array 202 in one of the supported formats (e.g., iSCSI, Fibre Channel, or any other protocol). The storage OS interface 648 provides console capabilities for managing the storage array 202 by communicating with the active controller 220 and the storage OS 606 executing therein. It should be understood, however, that specific implementations may utilize different modules, different protocols, different number of controllers, etc., while still being configured to execute or process operations taught and disclosed herein.

In some embodiments, a plurality of storage arrays may be used in data center configurations or non-data center configurations. A data center may include a plurality of servers, a plurality of storage arrays, and combinations of servers and other storage. It should be understood that the exact configuration of the types of servers and storage arrays incorporated into specific implementations, enterprises, data centers, small office environments, business environments, and personal environments, will vary depending on the performance and storage needs of the configuration.

In some embodiments, servers may be virtualized utilizing virtualization techniques, such that operating systems can be mounted on hypervisors to allow hardware and other resources to be shared by specific applications. In virtualized environments, storage is also accessed by virtual hosts that provide services to the various applications and provide data and store data to storage. In such configurations, the storage arrays can be configured to service specific types of applications, and the storage functions can be optimized for the type of data being serviced.

For example, a variety of cloud-based applications are configured to service specific types of information. Some information requires that storage access times are sufficiently fast to service mission-critical processing, while other types of applications are designed for longer-term storage, archiving, and more infrequent accesses. As such, a storage array can be configured and programmed for optimization that allows servicing of various types of applications. In some embodiments, certain applications are assigned to respective volumes in a storage array. Each volume can then be optimized for the type of data that it will service.

As described with reference to FIG. 6, the storage array 202 can include one or more controllers 220, 224. One controller serves as the active controller 220, while the other controller 224 functions as a backup controller (standby). For redundancy, if the active controller 220 were to fail, immediate transparent handoff of processing (i.e., fail-over) can be made to the standby controller 224. Each controller is therefore configured to access storage 1130, which in one embodiment includes hard disk drives (HDD) 226 and solid-state drives (SSD) 228. As mentioned above, SSDs 228 are utilized as a type of flash cache, which enables efficient reading of data stored to the storage 1130.

As used herein, SSDs functioning as “flash cache,” should be understood to operate the SSD as a cache for block level data access, providing service to read operations instead of only reading from HDDs 226. Thus, if data is present in SSDs 228, reading will occur from the SSDs instead of requiring a read to the HDDs 226, which is a slower operation. As mentioned above, the storage operating system 606 is configured with an algorithm that allows for intelligent writing of certain data to the SSDs 228 (e.g., cache-worthy data), and all data is written directly to the HDDs 226 from NVRAM 218.

The algorithm, in one embodiment, is configured to select cache-worthy data for writing to the SSDs 228, in a manner that provides an increased likelihood that a read operation will access data from SSDs 228. In some embodiments, the algorithm is referred to as a cache accelerated sequential layout (CASL) architecture, which intelligently leverages unique properties of flash and disk to provide high performance and optimal use of capacity. In one embodiment, CASL caches “hot” active data onto SSD in real time—without the need to set complex policies. This way, the storage array can instantly respond to read requests—as much as ten times faster than traditional bolt-on or tiered approaches to flash caching.

For purposes of discussion and understanding, reference is made to CASL as being an algorithm processed by the storage OS. However, it should be understood that optimizations, modifications, additions, and subtractions to versions of CASL may take place from time to time. As such, reference to CASL should be understood to represent exemplary functionality, and the functionality may change from time to time, and may be modified to include or exclude features referenced herein or incorporated by reference herein. Still further, it should be understood that the embodiments described herein are just examples, and many more examples and/or implementations may be defined by combining elements and/or omitting elements described with reference to the claimed features.

In some implementations, SSDs 228 may be referred to as flash, or flash cache, or flash-based memory cache, or flash drives, storage flash, or simply cache. Consistent with the use of these terms, in the context of storage array 102, the various implementations of SSD 228 provide block level caching to storage, as opposed to instruction level caching. As mentioned above, one functionality enabled by algorithms of the storage OS 606 is to provide storage of cache-worthy block level data to the SSDs, so that subsequent read operations are optimized (i.e., reads that are likely to hit the flash cache will be stored to SSDs 228, as a form of storage caching, to accelerate the performance of the storage array 102).

In one embodiment, it should be understood that the “block level processing” of SSDs 228, serving as storage cache, is different than “instruction level processing,” which is a common function in microprocessor environments. In one example, microprocessor environments utilize main memory, and various levels of cache memory (e.g., L1, L2, etc.). Instruction level caching, is differentiated further, because instruction level caching is block-agnostic, meaning that instruction level caching is not aware of what type of application is producing or requesting the data processed by the microprocessor. Generally speaking, the microprocessor is required to treat all instruction level caching equally, without discriminating or differentiating processing of different types of applications.

In the various implementations described herein, the storage caching facilitated by SSDs 228 is implemented by algorithms exercised by the storage OS 606, which can differentiate between the types of blocks being processed for each type of application or applications. That is, block data being written to storage 630 can be associated with block data specific applications. For instance, one application may be a mail system application, while another application may be a financial database application, and yet another may be for a website-hosting application. Each application can have different storage accessing patterns and/or requirements. In accordance with several embodiments described herein, block data (e.g., associated with the specific applications) can be treated differently when processed by the algorithms executed by the storage OS 606, for efficient use of flash cache 228.

Continuing with the example of FIG. 6, that active controller 220 is shown including various components that enable efficient processing of storage block reads and writes. As mentioned above, the controller may include an input output (IO) 210, which can enable one or more machines to access functionality of the storage array 202. This access can provide direct access to the storage array, instead of accessing the storage array over a network. Direct access to the storage array is, in some embodiments, utilized to run diagnostics, implement settings, implement storage updates, change software configurations, and/or combinations thereof. As shown, the CPU 608 is communicating with storage OS 606.

It should be apparent, that the present embodiments may be practiced without some or all of these specific details. Modification to the modules, code and communication interfaces are also possible, so long as the defined functionality for the storage array or modules of the storage array is maintained. In other instances, well-known process operations have not been described in detail in order not to unnecessarily obscure the present embodiments.

One or more embodiments can also be fabricated as computer readable code on a non-transitory computer readable storage medium. The non-transitory computer readable storage medium is any non-transitory data storage device that can store data, which can thereafter be read by a computer system. Examples of the non-transitory computer readable storage medium include hard drives, network attached storage (NAS), read-only memory, random-access memory, CD-ROMs, CD-Rs, CD-RWs, magnetic tapes and other optical and non-optical data storage devices. The non-transitory computer readable storage medium can include computer readable storage medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the described embodiments and sample appended claims.

1. A method for triggering a failover between an active controller and a standby controller of a storage array, comprising:
determining by the active controller a number of connected fabrics available between ports of the active controller and a host;
determining by the standby controller a number of connected fabrics available between the ports of the standby controller and the host; and
executing a policy configuration to determine if the number of connected fabrics for each of the active controller and the standby controller meet a threshold for triggering the failover.

2. The method of claim 1, further comprising,
comparing the number of connected fabrics between the ports of the active controller and the standby controller and the host, wherein the comparing is used by the policy configuration to determine if the threshold for triggering the failover is present.

3. The method of claim 1, wherein the policy configuration is selectable to change the threshold for triggering the failover.

4. The method of claim 1, wherein the failover is a process that switches a designation and functionality of the active controller and the standby controller, such that the active controller takes a role of the standby controller and the standby controller takes a role of the active controller.

5. The method of claim 1, wherein the policy configuration requires that the standby controller have more connected fabrics than does the active controller to meet the threshold for triggering the failover, the failover being a process that switches a designation and functionality of the active controller and the standby controller, such that the active controller takes a role of the standby controller and the standby controller takes a role of the active controller.

6. The method of claim 1, wherein the policy configuration requires that the standby controller have more than zero connected fabrics and the active controller has zero connected fabrics to meet the threshold for triggering the failover, the failover being a process that switches a designation and functionality of the active controller and the standby controller, such that the active controller takes a role of the standby controller and the standby controller takes a role of the active controller.

7. The method of claim 1, wherein the policy configuration requires that the standby controller have all connected fabrics of the active controller, plus some other connected fabric to meet the threshold for triggering the failover, the failover being a process that switches a designation and functionality of the active controller and the standby controller, such that the active controller takes a role of the standby controller and the standby controller takes a role of the active controller.

8. The method of claim 1, wherein the threshold for triggering the failover further requires detecting a drop in performance of the storage array.

9. The method of claim 1, wherein the policy configuration is dynamically adjusted based on a type of data being processed or during specific periods of time.

10. The method of claim 1, wherein the failover is a forceful trigger based on analysis of the connected fabrics to the active controller and the standby controller operating a Fibre Channel process.

11. The method of claim 1, wherein an override setting is triggered to prevent the failover during operation of certain administration tasks of the storage array.

12. A storage array, comprising,
an active controller for operating storage operations in accordance with a Fibre Channel protocol; and
a standby controller for operating storage operations in accordance with the Fibre Channel protocol;
the active controller and the standby controller being programmed to determine a number of connected fabrics available between ports of the active controller and the standby controller to a host, the active controller is configured to execute a policy configuration to determine if the number of connected fabrics for each of the active controller and the standby controller meet a threshold for triggering a failover.

13. The storage array of claim 12, wherein the policy configuration is configured to comparing the number of connected fabrics between the ports of the active controller and the standby controller and the host to determine if the threshold for triggering the failover is present.

14. The storage array of claim 12, wherein the policy configuration is selectable to change the threshold for triggering the failover.

15. The storage array of claim 12, wherein the failover is a process that switches a designation and functionality of the active controller and the standby controller, such that the active controller takes a role of the standby controller and the standby controller takes a role of the active controller.

16. The storage array of claim 12, wherein the policy configuration requires that the standby controller have more connected fabrics than does the active controller to meet the threshold for triggering the failover, the failover being a process that switches a designation and functionality of the active controller and the standby controller, such that the active controller takes a role of the standby controller and the standby controller takes a role of the active controller.

17. The storage array of claim 12, wherein the policy configuration requires that the standby controller have more than zero connected fabrics and the active controller has zero connected fabrics to meet the threshold for triggering the failover, the failover being a process that switches a designation and functionality of the active controller and the standby controller, such that the active controller takes a role of the standby controller and the standby controller takes a role of the active controller.

18. The storage array of claim 12, wherein the policy configuration requires that the standby controller have all connected fabrics of the active controller, plus some other connected fabric to meet the threshold for triggering the failover, the failover being a process that switches a designation and functionality of the active controller and the standby controller, such that the active controller takes a role of the standby controller and the standby controller takes a role of the active controller.

19. The storage array of claim 12, wherein the threshold for triggering the failover further requires detecting a drop in performance of the storage array.

20. Computer readable media having non-transitory program instructions for triggering a failover between an active controller and a standby controller of a storage array, comprising:
program instructions for determining by the active controller a number of connected fabrics available between ports of the active controller and a host;
program instructions for determining by the standby controller a number of connected fabrics available between the ports of the standby controller and the host; and
program instructions for executing a policy configuration to determine if the number of connected fabrics for each of the active controller and the standby controller meet a threshold for triggering the failover.

21. The computer readable media of claim 20, further comprising,
program instructions for comparing the number of connected fabrics between the ports of the active controller and the standby controller and the host, wherein the comparing is used by the policy configuration to determine if the threshold for triggering the failover is present, the failover is a process that switches a designation and functionality of the active controller and the standby controller, such that the active controller takes a role of the standby controller and the standby controller takes a role of the active controller.

22. The computer readable media of claim 20, wherein the policy configuration requires that the standby controller have more connected fabrics than does the active controller to meet the threshold for triggering the failover, the failover being a process that switches a designation and functionality of the active controller and the standby controller, such that the active controller takes a role of the standby controller and the standby controller takes a role of the active controller.

23. The computer readable media of claim 20, wherein the policy configuration requires that the standby controller have more than zero connected fabrics and the active controller has zero connected fabrics to meet the threshold for triggering the failover, the failover being a process that switches a designation and functionality of the active controller and the standby controller, such that the active controller takes a role of the standby controller and the standby controller takes a role of the active controller.

24. The computer readable media of claim 20, wherein the policy configuration requires that the standby controller have all connected fabrics of the active controller, plus some other connected fabric to meet the threshold for triggering the failover, the failover being a process that switches a designation and functionality of the active controller and the standby controller, such that the active controller takes a role of the standby controller and the standby controller takes a role of the active controller.
